(19) United States
(12) Patent Application Publication
(10) Pub. No.: US 2008/0309126 A1
(43) Pub. Date: Dec. 18, 2008

(54) Motor vehicle with a movable roof and an extendable rollover protection element

(75) Inventors: Dominik Beierl, Korntal-Munchingen (DE); Felix Hermann, Leonberg (DE)

Correspondence Address: LERNER GREENBERG STEMER LLP, P O BOX 2480, HOLLYWOOD, FL, 33022-2480, US

(73) Assignee: Dr. Ing. h.c. F. Porsche AG, Weissach (DE)

(21) Appl. No.: 12/103,243

(22) Filed: Apr. 15, 2008

(30) Foreign Application Priority Data
Jun. 16, 2007 (DE) 102007027740.9

(51) Int. Cl. B60J 7/00

(52) U.S. Cl. 296/216.01

(57) ABSTRACT

A motor vehicle has a body, a roof that can be displaced between an open position and closed position and having a roof skin with a rear window, and a rollover protection element that can be extended from an inoperative position into a protective position. In the protective position and with the roof in the closed position, the rollover protective element protrudes above the roof skin in the vicinity of the rear window. For improved rollover protection, it is proposed that the rear window is surrounded at least in some sections by a stiff window frame and is attached thereto, and that, in the closed position of the roof, the window frame is supported in relation to the body.

### CROSS-REFERENCE TO RELATED APPLICATION

This application claims the priority, under 35 U.S.C. § 119, of German application DE 10 2007 027 740.9, filed Jun. 16, 2007; the prior application is herewith incorporated by reference in its entirety.

### BACKGROUND OF THE INVENTION

### Field of the Invention

The invention is based on a motor vehicle with a movable roof and an extendable rollover protection element. The motor vehicle has a body, a roof which can be displaced between an open position and closed position and has a roof skin with a rear window, and a rollover protection element which can be extended from an inoperative position into a protective position. In the protective position and with the roof in the closed position, the rollover protection element protrudes above the roof skin in the vicinity of the rear window.

A motor vehicle of the type in question is known from published, non-prosecuted German patent application DE 10 2004 062 999 A1, corresponding to U.S. patent publication No. 20060131862 A. It has a movable roof in the form of a convertible top, in the roof skin of which a rear window is inserted. Furthermore, the motor vehicle has a rollover protection element that is configured as at least one roll bar disposed behind a vehicle seat. The roll bar is held in a receiving cassette in a manner such that it can be extended from a lowered or retracted inoperative position into an extended protective position that protrudes above the belt line of the motor vehicle. When the roof is arranged in the closed position, the roll bar extends to an extent such that it breaks through the roof skin or the rear window, thereby enabling the extension height of the roll bar to be selected independently of the position of the convertible top.

### BRIEF SUMMARY OF THE INVENTION

It is accordingly an object of the invention to provide a motor vehicle with a movable roof and an extendable rollover protection element that overcomes the above-mentioned disadvantages of the prior art devices of this general type, which improves rollover protection of the motor vehicle.

With the foregoing and other objects in view there is provided, in accordance with the invention, a motor vehicle. The motor vehicle contains a body and a roof being displacable between an open position and a closed position and having a roof skin with a rear window, and a stiff window frame at least partially surrounding the rear window. The rear window is attached to the stiff window frame, and in the closed position of the roof the stiff window frame is supported in relation to the body. A rollover protection element is provided and supported by the body and which can be extended from an inoperative position into a protective position. In the protective position and with the roof in the closed position, the rollover protection element protrudes above the roof skin in a vicinity of the rear window.

The advantages primarily obtained by the invention are that an enlarged protective region can be provided for the vehicle occupant/occupants independently of the position of the roof (open or closed position). The extension height of the rollover protection element is therefore selected optimally, but such that it remains constant, independently of the roof position. Furthermore, by the window frame according to the invention, the extending rollover protection element is opposed by a constant resistance which does not spring away or yield and which assists the breaking through of the roof skin, in particular of the rear window, by the rollover protection element. This is further improved according to the invention in that the rollover protection element breaks through the roof skin or the rear window in the vicinity of the roof frame. The rear window or the roof skin therefore cannot spring away or yield when the extending rollover protection element strikes against it.

In preferred embodiments, the window frame is held movably on the body and/or on a convertible top linkage of the roof, for example in an articulated manner via a lever configuration which extends between the window frame and the body and/or the convertible top linkage. An embodiment is particularly preferred, in which the window frame is at least partially held movably on a tensioning bow of the convertible top linkage.

It can therefore be provided that the rollover protection element pierces an opaque section of the roof skin or a transparent section, namely the rear window, or at least partially releases or separates the rear window from the roof skin or from the window frame. For this purpose, in a preferred embodiment, the rear window is equipped with a predetermined breaking point that further assists destruction of the rear window, and/or the rear window is held in the roof skin or on the window frame via a predetermined breaking point.

In order furthermore to favorably affect the destruction of the rear window or the piercing of the roof skin, in a preferred exemplary embodiment the rollover protection element is equipped with a piercing element, in particular a spike.

In a further exemplary embodiment, the movable roof is configured as a convertible top with a flexible convertible top fabric which, together with the rear window incorporated in it, can form the roof skin. However, it would be conceivable to configure the roof as a folding roof that has a fixed roof skin, for example made of sheet metal, into which the rear window is inserted together with its window frame.

Other features which are considered as characteristic for the invention are set forth in the appended claims.

Although the invention is illustrated and described herein as embodied in a motor vehicle with a movable roof and an extendable rollover protection element, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, side view of a first embodiment of a roof of a motor vehicle;

FIG. 2 is a diagrammatic, perspective view of the roof of the motor vehicle with a rollover protection element;

FIG. 3 is a diagrammatic, perspective view showing another angle of the rollover protection element;

FIG. 4 is a diagrammatic, side view of a second embodiment of the roof of the motor vehicle;

FIG. 5 is a diagrammatic, perspective view of the roof of the motor vehicle with the rollover protection element according to the second embodiment;

FIG. 6 is a diagrammatic, perspective view showing another angle on the rollover protection element according to the second embodiment; and

FIG. 7 is a diagrammatic, perspective detailed view of the roof.

### DETAILED DESCRIPTION OF THE INVENTION

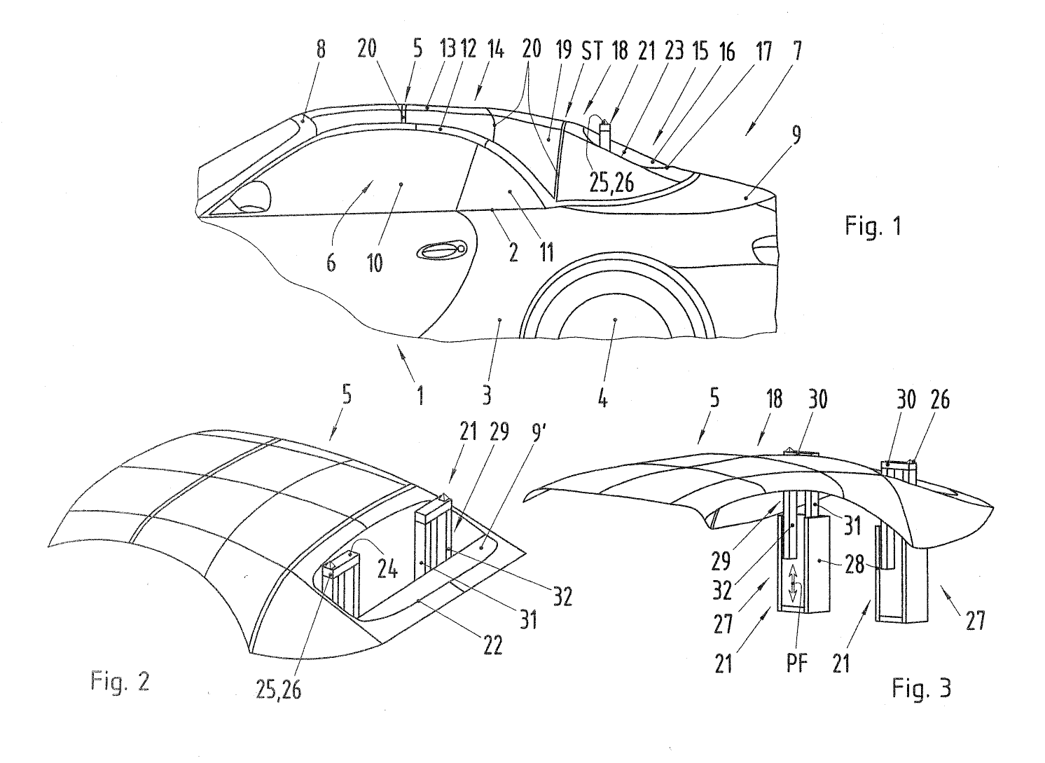

Referring now to the figures of the drawing in detail and first, particularly, to FIG. 1 thereof, there is shown in a side view, part of a motor vehicle 1, in particular a convertible, with a body 3 which has a belt line 2 which is supported by a chassis with wheels, of which only one wheel 4 is shown. In a closed position ST, a movable or displaceable roof 5 is disposed above the belt line 2, the roof spanning a passenger compartment 6 in a curved manner from a rear region 7 as far as an upper cowl 8 and, in a non-illustrated open position, being able to be put away in the rear region 7 in a convertible top compartment 9′ arranged below a movable convertible top compartment cover 9 (see FIG. 2). The passenger compartment 6 is also delimited laterally above the belt line 2 by movable side windows 10 and 11 which, in their raised position, reach to a lateral roof frame 12 of the roof 5.

The roof 5 has an external roof skin 13 which contains a first, opaque section 14 and, in particular in the vicinity of the rear region 7, a second, transparent section 15. The second section 15 is formed, in particular, by a rear window 16 that is inserted into the roof skin 13 and is configured as a rigid pane that is inserted into a cutout 17 in the roof skin 13. The roof 5 is preferably configured as a convertible top 18 and, as the first section 14, has a flexible convertible top cloth 19 which is supported by a convertible top linkage 20, only part of which can be seen here and which is also assigned the roof frame 12.

In the passenger compartment 6, at least one rollover protection element 21 is arranged behind non-illustrated vehicle seats and in front of the convertible top compartment 9′, the rollover protection element 21 being able to be displaced from a non-illustrated retracted inoperative position into an extended protective position ZT in which it protrudes above the belt line 2. The inoperative position can lie below or in the vicinity of the belt line 2. In the protective position ZT, the rollover protection element 21 has penetrated the roof skin 13 and thus protrudes above the latter, as illustrated in the various views in FIGS. 1 to 3. In particular, in the inoperative position, the rollover protection element 21 is arranged below the transparent section 15 and, in order to reach the protective position ZT, penetrates the plane 22 of the section, in which plane 22 the rear window 16 lies. In order to be able to take up the protective position ZT, the rollover protection element 21 breaks through the roof skin 13, for example the rear window 16, by at least partial destruction of the roof skin 13, in particular of the rear window 16, which is therefore detached from the opaque, first section 14 of the roof skin 13. In order to facilitate the breaking through of the rear window 16, the latter can have a predetermined breaking point 23 which is formed by a material weakening in the window glass (preferably toughened safety glass). For the destruction of the rear window 16, and in general for the breaking through of the roof skin, the rollover protection element 21 can have, on its upper side 24 which faces the roof skin 13, a point-shaped, locally fitted piercing element 25 which can be configured as a spike 26 and is preferably fitted as far as possible to the outside or inside of the rollover protection element 21 such that it even strikes against a rear window 16 which is of curved design.

As is apparent from FIGS. 2 and 3, two rollover protection elements 21 which are arranged next to each other can be inserted into the motor vehicle 1. Each of the elements 21 is configured as a cassette 27 with a fastening and guide frame 28 and a roll bar 29 which is guided in a height-displaceable manner therein (arrow PF) and has a base 30 (upper side 24) and two guide limbs 31 and 32. In order for it to be possible for the roll bar 29 to be moved into the protective position ZT, a sensor (not illustrated) with a corresponding control device is provided for a triggering control of the roll bar 29 held in the inoperative position. Sensor and control device recognize the start of the motor vehicle 1 rolling over and release the roll bar 29, which is preferably prestressed in the direction of the protective position ZT, via a triggering mechanism. However, sensor, control device and triggering mechanism are known, and therefore further description thereof is omitted.

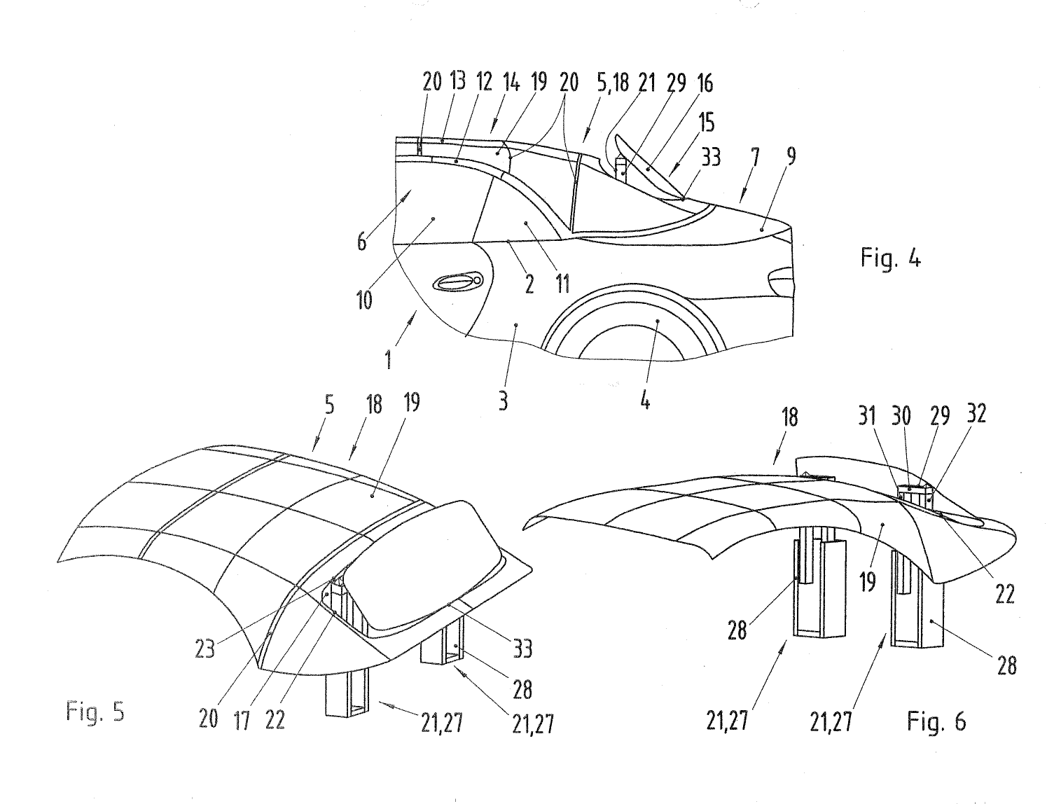

A second exemplary embodiment of the roof 5 is described with reference to FIGS. 4 to 6. Parts which are identical or act in an identical manner are provided with the same reference numbers as in FIGS. 1 to 3, and vice-versa. The predetermined breaking point 23 lies between the rear window 16 and the first, opaque section 14 of the roof skin 13. The rear window 16 is inserted into the roof skin 13, this not being illustrated in FIGS. 3 to 6; at any rate, the rear window 16 is in its normal position in the plane 22. The predetermined breaking point 23 can be formed merely on part of the cutout 17 or in a manner encircling it, and therefore the rear window 16 can be folded back about a folding axis 33 so that the rollover protection element 21 can be brought into its protective position ZT without destroying the rear window 16; however, a combination of destruction and separating out of the rear window 16 would also be conceivable. Irrespective thereof, according to the second exemplary embodiment, the rollover protection element 21 also breaks through the plane 22 of the rear window 16 such that it can protrude above the roof skin 13 when it is moved into the protective position ZT.

When the roof 5 is open (not shown), the rollover protection element 21 is displaced into the same protective position ZT, i.e. is brought into an identical extension height. Irrespective of the position of the roof 5, an expanded region of protection for the occupant/occupants of the motor vehicle 1 is provided below an imaginary tangent to cowl 8 and upper side 24 of the rollover protection element 21.

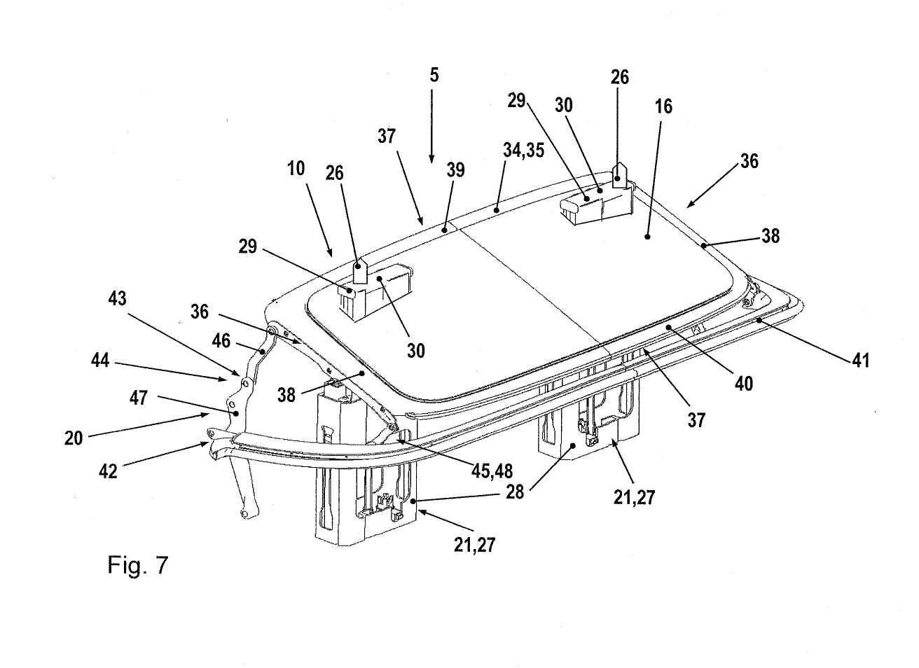

Irrespective of the above-described exemplary embodiments, the roof 5 illustrated is always equipped with a stiff or inflexible frame element 34 (FIG. 7) that supports the roof skin 13 in a section, here the transparent section 15. The rollover protection element 21 is located below the section that is to be broken through, the rollover protection element 21 breaking through the section in the vicinity of the frame element 34 in order to reach the protective position ZT. In the exemplary embodiment shown, the frame element 34 is a window frame 35 that borders the rear window 16 and merely partially surrounds the rear window 16 or surrounds it in an encircling manner. The rear window 16 is fastened to the window frame 35. The convertible top cloth 19 can likewise be fastened to the frame element 34 or 35. In the exemplary embodiment, the approximately right-angled window frame 35 is realized in an encircling manner with two narrow sides 36 and two longitudinal sides 37 and has correspondingly lateral frame limbs 38 and an upper and lower frame limb 39 and 40.

In addition to elements (not illustrated here) for moving the roof 5 between the open and closed positions, a convertible top linkage 20 also contains at least one rear, U-shaped delimitation, in particular tensioning bow 41, which is held movably by its ends 42 on the convertible top linkage 20 and/or on the body 3. The rollover protection element 21 is fastened to the body 3.

In the closed position ST of the roof 5, the frame element 34 or the window frame 35 is supported in relation to the body 3 in such a manner that it cannot yield or spring away in relation to the rollover protection element 21 when the rollover protection element 21 strikes against that section of the roof skin 13 which is to be broken through. In one exemplary embodiment, the frame element 34 can be held movably directly on the body 3 (for example on a convertible top bearing (not shown)), for which purpose at least one linkage 43 and/or joint is provided on each narrow side 36. The linkage 43 preferably contains a front and/or rear lever arrangement 44, 45 which has at least one lever 46 or 47 or 48 and which is connected in an articulated manner both to the body 3 and the frame element 34 such that the frame element 34 can be put away by it, as customary for convertibles, in order to reach the open position of the roof 5. The front lever arrangement 44 is connected in an articulated manner to the frame element 34 in the vicinity of the upper frame limb 39 and is realized, for example, by one lever or by levers 46, 47 connected to each other in an articulated manner. The rear lever arrangement 45 contains, in particular, a single lever 48 which is connected in an articulated manner to the frame element 34 in the vicinity of the lower frame limb 40.

As an alternative—as FIG. 7 shows—the frame element 34 can be held movably on the convertible top linkage 20 via the previously described linkage 43. In this case, the rear lever arrangement 45 extends between the frame element 34 and the tensioning bow 41 while the front lever arrangement 44 is arranged between the frame element 34 and another element of the convertible top linkage 20 or the body 3; it would be conceivable to movably connect the front lever arrangement 44 to the tensioning bow 41. In any case, the linkage 43 prevents the extending rollover protection element 21 from merely pushing away the frame part without, in the process, breaking through the roof skin 13.

1. A motor vehicle, comprising:
a body;
a roof being displaceable between an open position and a closed position and having a roof skin with a rear window, and a stiff window frame at least partially surrounding said rear window, said rear window attached to said stiff window frame, and in the closed position of said roof said stiff window frame being supported in relation to said body; and
a rollover protection element supported by said body and which can be extended from an inoperative position into a protective position and, in the protective position and with said roof in the closed position, said rollover protection element protrudes above the roof skin in a vicinity of said rear window.

2. The motor vehicle according to claim 1, wherein said stiff window frame is held movably on said body.

3. The motor vehicle according to claim 1, further comprising a convertible top linkage, said stiff window frame being held movably on said convertible top linkage.

4. The motor vehicle according to claim 3, wherein said convertible top linkage has a tensioning bow on which said stiff window frame is held movably.

5. The motor vehicle according to claim 3, wherein:
said stiff window frame has an upper frame limb and a lower frame limb; and
said convertible top linkage has a lever configuration, said stiff window frame is supported in relation to said body by said lever configuration both in a region of said upper frame limb and said lower frame limb.

6. The motor vehicle according to claim 1, wherein said rear window is disposed in said roof skin of said roof, and in the protective position said rollover protection element pierces a plane of said rear window.

7. The motor vehicle according to claim 6, wherein during a movement from the inoperative position into the protective position, said rollover protection element at least partially destroys said rear window.

8. The motor vehicle according to claim 6, wherein during a movement from the inoperative position into the protective position, said rollover element at least partially separates said rear window from said roof skin.

9. The motor vehicle according to claim 1, wherein:
the motor vehicle is a convertible; and
said body has a belt line, and said roof is disposed above said belt line of said body of said convertible.

10. The motor vehicle according to claim 9, wherein said roof has a convertible top with a convertible top cloth constituting said roof skin.

11. The motor vehicle according to claim 1, wherein said rollover protection element has an upper side facing said roof skin and a piercing element on said upper side.

12. The motor vehicle according to claim 1, wherein said rear window has a predetermined breaking point.

13. The motor vehicle according to claim 1, wherein said rear window is held in said roof skin, namely on said stiff rear window, via a predetermined breaking point.

14. The motor vehicle according to claim 6, wherein during a movement from the inoperative position into the protective position, said rollover protection element at least partially separates said rear window from said stiff window frame.
